(19) United States
(12) Patent Application Publication
(10) Pub. No.: US 2026/0210365 A1
(43) Pub. Date: Jul. 23, 2026

(54) FAN MOTOR

(71) Applicant: LG ELECTRONICS INC., Seoul (KR)

(72) Inventors: Joohang KANG, Seoul (KR); Jounyoung KIM, Seoul (KR); Taekyung KIM, Seoul (KR); Yongdae KIM, Seoul (KR); Hyeonho HA, Seoul (KR)

(21) Appl. No.: 19/442,173

(22) Filed: Jan. 7, 2026

(30) Foreign Application Priority Data
Jan. 17, 2025 (KR) 10-2025-0007518

(51) Int. Cl. F04D 25/06; F04D 25/08; F04D 29/32; F04D 29/54

(52) U.S. Cl. CPC F04D 25/06; F04D 25/08; F04D 29/325; F04D 29/542

(57) ABSTRACT

There is disclosed a fan motor including an impeller configured to suction air as it rotates about a shaft of a motor; an impeller cover configured to accommodate the impeller therein; and a guide vane configured to guide air discharged from the impeller, and at least a portion of an outer peripheral surface of the impeller cover may be coupled to an inner peripheral surface of an outer wall of the guide vane.

This application claims priority to and the benefit of Korean Patent Application No. 10-2025-0007518, filed on January 17, 2025, the disclosure of which is incorporated herein by reference in its entirety.

### BACKGROUND

### Technical Field

Embodiments of the present disclosure relate to a fan motor and a cleaner having the same, more particularly, to a fan motor that may generate air flow by rotating an impeller attached to the motor shaft.

### Background of the Disclosure

A fan motor generates suction by rotating a fan (impeller) connected to a motor's shaft. Fan motors are used in various devices. They are used in home appliances such as cleaners, air conditioners, and automobiles. For example, when a fan motor is used in a cleaner, the air sucked in by the fan motor flows through the cleaner's filter.

A fan motor typically consists of a motor and an impeller connected to the motor's shaft. Guide vanes may be installed between the motor and the impeller.

As the motor rotates, the impeller connected to the motor's shaft also rotates. The rotation of the impeller draws air toward the impeller. The air exiting the impeller is guided by the guide vanes and discharged toward the motor.

The air flow discharged from the impeller enters the motor. This air dissipates heat from the motor and is then discharged to the outside of the motor.

Meanwhile, home appliances such as cleaners are undergoing miniaturization and weight reduction for user convenience. At this time, a reduction in the maximum outer diameter of a fan motor is effective in achieving miniaturization and weight reduction.

In this regard, International Patent Publication No. WO 2018-043931A1 discloses a vacuum cleaner equipped with a fan motor.

The fan motor of the vacuum cleaner is configured such that the impeller cover covers the outer surface of the outer wall of the guide vane. In this case, the thickness of the impeller cover increases radially outward from the guide vane, limiting the increase in the overall outer diameter of the fan motor.

Furthermore, in the case of the fan motor described above, adhesive is applied to the inner surface of the impeller cover. When the outer wall of the guide vane is inserted into the impeller cover, a portion of the adhesive is exposed to the inner surface of the airflow path, limiting the efficiency of the path.

Meanwhile, U.S. Publication No. US 20190191949A1 discloses a fan motor in which the impeller cover is coupled to a secondary guide vane.

The fan motor described above may be supported by having a slit formed in the blade of the guide vane, and a protrusion formed in the impeller cover being fitted into the slit.

However, when the impeller cover is coupled to the blade slit of the guide vane as described above, there is a gap through which air leaks between the guide vane and the inner surface of the impeller cover, which has a limitation in that the flow efficiency is reduced.

### SUMMARY

Accordingly, one object of the embodiments of the present disclosure is to solve the above-noted disadvantages of the prior art, and to provide a fan motor that may be made smaller and lighter by reducing the maximum outer diameter of the fan motor.

Another object of the embodiments of the present disclosure is to provide a fan motor that may improve suction power while reducing the maximum outer diameter of the fan motor.

A further object of the embodiments of the present disclosure is to provide a fan motor that may prevent the flow path inside the fan motor from being blocked by adhesive, thereby reducing flow path efficiency.

To solve the objects of the present disclosure, according to an embodiment of the present disclosure, a fan motor may include an impeller configured to suction air as it rotates about a shaft of a motor; an impeller cover configured to accommodate the impeller therein; and a guide vane configured to guide air discharged from the impeller, and at least a portion of an outer peripheral surface of the impeller cover may be coupled to an inner peripheral surface of an outer wall of the guide vane.

At this time, the guide vane may further include an inner wall having a plurality of vane blades formed on an outer peripheral surface thereof, and the plurality of vane blades may be connected to an inner peripheral surface of the outer wall.

At this time, the guide vane may have a cover coupling groove formed along a circumferential direction between a radially outer end of the vane blade and the inner peripheral surface of the outer wall.

At this time, an axially one end of the impeller cover may be accommodated in the cover coupling groove.

Meanwhile, a diameter of an outer peripheral surface of the impeller cover may be equal to a diameter of an inner peripheral surface of the outer wall of the guide vane.

Through this, the impeller cover may be inserted into the outer wall of the guide vane.

Meanwhile, the impeller cover may include a cover body having an outer diameter that increases toward the guide vane; and an insertion portion inserted into and coupled to an outer wall of the guide vane.

At this time, an adhesive may be applied to an outer peripheral surface of the insertion portion.

Accordingly, in a state where the insertion portion is inserted into an outer wall of the guide vane, the adhesive may seal between at least a portion of an outer peripheral surface of the cover body and an inner peripheral surface of an outer wall of the guide vane.

Meanwhile, a bonding groove may be formed along a circumferential direction on an outer peripheral surface of the insertion portion.

Meanwhile, a maximum diameter of the guide vane may be greater than a maximum diameter of the impeller cover.

Meanwhile, the height from the cover joining groove to the top of the outer wall may be greater than the height of the insertion portion.

Accordingly, when an adhesive is applied to the outer surface of the insertion portion and the insertion portion is inserted into the inner surface of the outer wall, a portion of the adhesive may seal the upper surface of the insertion portion and the inner surface of the outer wall.

As described above, in the fan motor of the present disclosure, the impeller cover may be inserted into the inner circumference of the outer wall of the guide vane, thereby reducing the maximum outer diameter of the fan motor.

According to the embodiments of the present disclosure, the fan motor may improve suction power while reducing the maximum outer diameter of the fan motor.

According to the embodiments of the present disclosure, the fan motor may prevent the flow path within the fan motor from being blocked by adhesive, thereby reducing flow path efficiency.

### DESCRIPTION OF DRAWINGS

FIG. 1 is a perspective view illustrating a fan motor according to an embodiment of the present disclosure;

FIG. 2 is a side view of FIG. 1;

FIG. 3 is a cross-sectional view of FIG. 2;

FIG. 4 is a perspective view illustrating a guide vane in a fan motor according to an embodiment of the present disclosure;

FIG. 5 is a cross-sectional view illustrating a cover coupling groove in a fan motor according to an embodiment of the present disclosure;

FIG. 6 is a cross-sectional view illustrating an assembly process of a fan motor according to an embodiment of the present disclosure;

FIG. 7 is a cross-sectional view illustrating an assembled state of a fan motor according to an embodiment of the present disclosure;

FIG. 8 is a drawing illustrating a bonding groove in a fan motor according to an embodiment of the present disclosure; and

FIG. 9 is a cross-sectional view illustrating a bonding groove in a fan motor according to an embodiment of the present disclosure.

### DESCRIPTION OF SPECIFIC EMBODIMENTS

Hereinafter, preferred embodiments of the present disclosure will be described in detail with reference to the accompanying drawings.

The present disclosure is susceptible to various modifications and embodiments. Therefore, specific embodiments are illustrated in the drawings and specifically described in the detailed description. This is not intended to limit the present disclosure to specific embodiments, but should be interpreted to include all modifications, equivalents, and alternatives falling within the spirit and technical scope of the present disclosure.

In describing the present disclosure, terms such as "first" and "second" may be used to describe various components; however, these components may not be limited by these terms. These terms are used solely to distinguish one component from another. For example, without departing from the scope of the present disclosure, a first component could be referred to as a "second component," and similarly, a second component could also be referred to as a "first component."

The term "and/or" may encompass any combination of multiple related items or any of multiple related items.

When a component is referred to as being "connected" or "coupled" to another component, it may be understood that it may be directly connected or connected to that other component, but there may also be other components present in between. Conversely, when a component is referred to as being "directly connected" or "directly connected" to another component, it may be understood that there are no other components present in between.

The terminology used in this application is used solely to describe specific embodiments and is not intended to limit the present disclosure. The singular expression "singular" may include plural expressions unless the context clearly indicates otherwise.

In this application, terms such as "comprise" or "include" indicate the presence of features, numbers, steps, operations, components, parts, or combinations thereof described in the specification, and should be understood not to preclude the presence or addition of one or more other features, numbers, steps, operations, components, parts, or combinations thereof.

Unless otherwise defined, all terms used herein, including technical or scientific terms, have the same meaning as commonly understood by those of ordinary skill in the art to which the present disclosure pertains. Terms defined in commonly used dictionaries may be interpreted as having a meaning consistent with their meaning in the context of the relevant technology, and, unless explicitly defined herein, may not be interpreted in an idealized or overly formal sense.

Furthermore, the following examples are provided to provide a more complete explanation to those of average skill in the art. The shapes and sizes of elements in the drawings may be exaggerated for clarity.

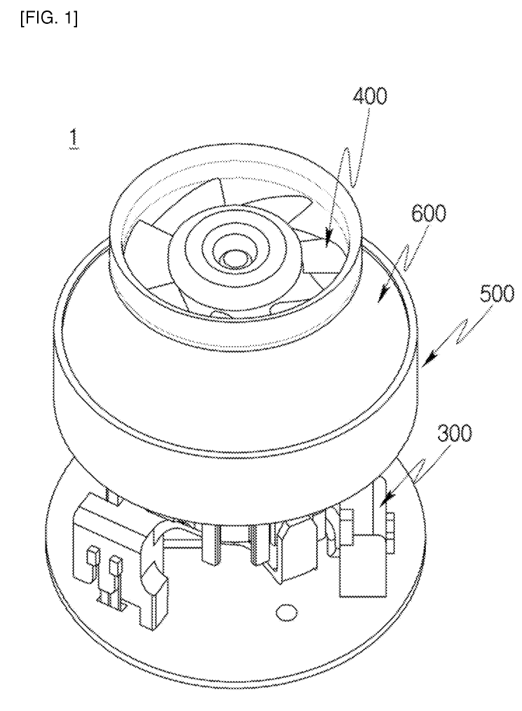

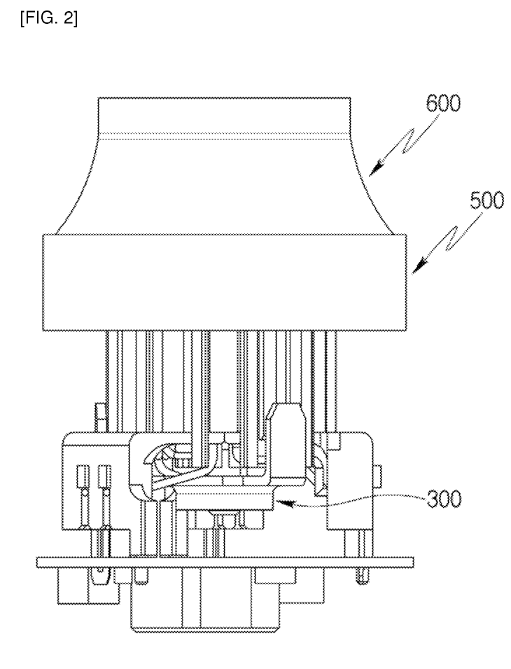

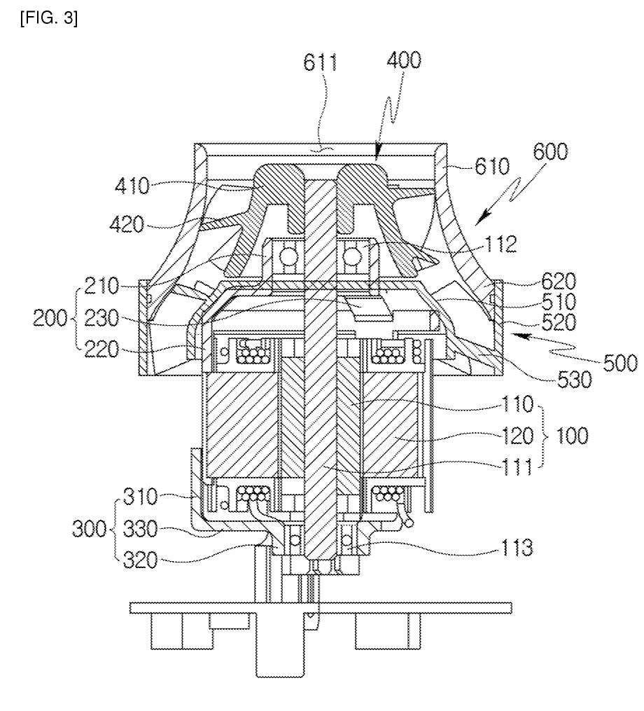

FIGS. 1 to 3 illustrate a fan motor according to an embodiment of the present disclosure.

Referring to FIGS. 1 to 3, the fan motor 10 according to an embodiment of the present disclosure will be described as follows.

A motor 100 may include a stator 120 and a rotor 110. The rotor 110 may be rotatably positioned within the stator 120. The rotor 110 may be formed in a hollow cylindrical shape.

The rotor 110 may include a rotor core fixed to a shaft 111, a magnet installed on the rotor core, and a pair of end plates for fixing the magnet.

The rotor 110 may be mounted to surround a portion between one axial end and the other axial end of the shaft 111.

The shaft 111 may be arranged from the inside of the motor housing 300 to the inside of the impeller cover 600. The shaft 111 may be rotatably positioned within a motor housing 300 and an impeller cover 600.

The shaft 111 may be supported by bearings 112, 113 to rotate together with the rotor 110. The shaft 111 may be rotated by the rotor 110 while being supported by the bearings 112, 113.

The impeller 400 may be connected to the shaft 111, and when the shaft 111 rotates, the impeller 400 may rotate within the impeller cover 600. Therefore, when the motor 100 rotates, the impeller 400 also rotates, generating suction force to suck in air.

The stator 120 may be mounted to the motor housing 300. The stator 120 may be mounted to the motor housing 300 and may be arranged to surround the rotor 110. The stator 120 may be mounted to the motor housing 300 using a coupling member, such as a screw.

The stator 120 may be formed in a hollow cylindrical shape. The stator 120 may be mounted to surround the outer perimeter of the rotor 110.

The stator 120 may be composed of a combination of multiple members. The stator 120 may include a stator core, a pair of inserters coupled to the stator core, and coils arranged in the inserters.

A motor bracket 200 may rotatably support the upper portion of the shaft 111 of the rotor 110. In addition, a guide vane 500 may be coupled to the upper portion of the motor bracket 200. The motor bracket 200 may be coupled to the guide vane 500 to support the guide vane 500.

An upper bearing housing 210 may be provided at the center of the motor bracket 200. An upper bearing 112 may be accommodated in the upper bearing housing 210. The upper bearing housing 210 may be formed in a shape that accommodates the upper bearing 112. For example, the upper bearing housing 210 may be formed in a cylindrical shape. The upper bearing 112 may be arranged radially outside the shaft 111.

Meanwhile, the motor bracket 200 may be provided with a support portion 220. For example, the support portion 220 may be formed in a ring shape. Furthermore, the support portion 220 may have a predetermined height in the vertical direction.

Furthermore, a bridge 230 may be provided between the upper bearing housing 210 and the support portion 220. The bridge 230 may connect the upper bearing housing 210 and the support portion 220. That is, one side of the bridge 230 may be connected to the upper bearing housing 210, and the other side may be connected to the support portion 220. At this time, there is a height difference between the upper bearing housing 210 and the support portion 220. Therefore, the upper end of the bridge 230 may be connected to the upper bearing housing 210, and the lower end may be connected to the support portion 220).

A plurality of bridges 230 may be arranged along the circumference on the outside of the upper bearing housing 210. The bridges 230 may have any shape as long as they perform the function of connecting the upper bearing housing 210 and the support portion 220. For example, the bridges 230 may be bar-shaped.

The motor housing 300 may accommodate at least a portion of the motor 100. The motor housing 300 may include a motor housing body 310, a lower bearing housing 320, and a connecting portion 330.

The motor housing body 310 may accommodate one longitudinal side of the motor 100. For example, the motor housing body 310 may accommodate a portion of the lower side of the motor 100.

The motor housing 300 may be connected to the motor bracket 200. Accordingly, the motor 100 may be accommodated in the internal space formed by connecting the motor housing 300 and the motor bracket 200.

The motor housing body 310 may have an overall hollow cylindrical shape. Air introduced into the motor 100 may be discharged to the outside of the motor housing body 310. For example, air drawn into the motor 100 may be discharged to the outside through an opening formed in the lower portion of the motor housing body 310.

A lower bearing housing 320 may be provided at the lower portion of the motor housing body 310, in which a lower bearing 113 is mounted. A connecting portion 330 connecting the lower bearing housing 320 and the motor housing body 310 may be provided.

Meanwhile, the stator 120 may be coupled to the inner surface of the motor housing body 310. The rotor 110 may be rotatably arranged at the center of the motor housing body 310. At this time, the lower portion of the shaft 111 may be rotatably supported by the lower bearing housing 320.

Accordingly, the upper portion of the shaft 111 may be rotatably supported by the upper bearing housing 210. Additionally, the lower portion of the shaft 111 may be rotatably supported on the lower bearing housing 320.

The impeller 400 may generate a suction force to suck in air as it rotates around the shaft 111.

The impeller 400 may be configured as a centrifugal impeller that sucks in air in the axial direction and blows it in the centrifugal direction, or as a diagonal impeller that sucks in air in the axial direction and blows it in an oblique direction between the axial and centrifugal directions.

The impeller 400 may include a hub 410 connected to the shaft 111 and at least one blade 420 formed on the outer surface of the hub 410.

The hub 410 may be connected to an end of the shaft 111 located inside the impeller cover 600. That is, the hub 410 may be coupled to the upper end of the shaft 111.

A hollow portion into which the shaft 111 is inserted may be formed at the center of the hub 410.

The hub 410 may be formed in a shape in which its outer diameter gradually increases in a direction approaching the rotor 110.

The hub 410 may have a smallest outer diameter at one axial end close to the air inlet 611 formed in the impeller cover 600, and a largest outer diameter at the other axial end close to the rotor 110. The maximum outer diameter of the hub 410 may be the outer diameter of the end of the hub 410 that is closest to the rotor 110.

A plurality of blades 420 may be formed on the outer surface of the hub 410, and the plurality of blades 420 may be arranged spaced apart from each other along the circumferential direction of the impeller 400.

The blade 420 may be formed in a curved plate shape, and both sides thereof may include a pressure-side surface and a suction-side surface.

The blade 420 may be formed in a three-dimensional shape, and may include a leading edge at the frontmost end in the airflow direction and a trailing edge at the rearmost end in the airflow direction.

The blade 420 may have a blade tip positioned most outerward relative to the central axis of the hub 410. The blade tip may be an outer tip positioned most outerward among the blades 420.

The blade 420 may have a leading edge and a trailing edge connected to the blade tip. The blade tip may connect the tip of the leading edge that is furthest from the hub 410 and the tip of the trailing edge that is furthest from the hub 410.

When the impeller 400 rotates, some of the air flowed by the impeller 400 may pass over the blade tip due to the pressure difference between the pressure surface and the negative pressure surface of the blade 420, and this flow may become leakage flow.

When the impeller 400 rotates, the area around the pressure surface may be relatively high pressure, and the area around the negative pressure surface may be relatively low pressure. If the tip clearance between the blade tip and the inner circumference of the impeller cover 600 is large, the air around the pressure surface may move over the blade tip to the area around the negative pressure surface, and a vortex may be formed around the area around the negative pressure surface.

If the tip clearance between the blade tip and the impeller cover 600 is large, the amount of leakage flow increases, and it is preferable that this gap be set so as to minimize the leakage flow.

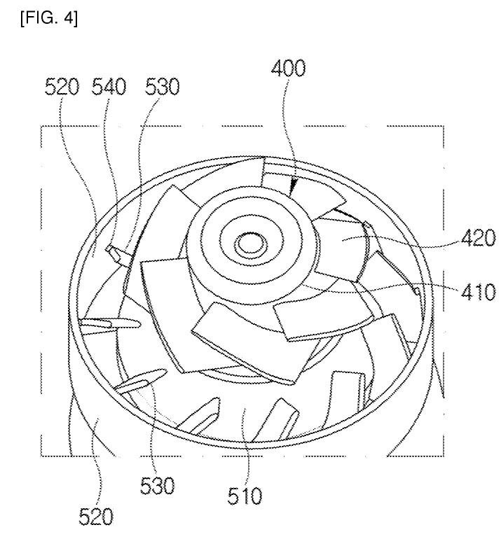

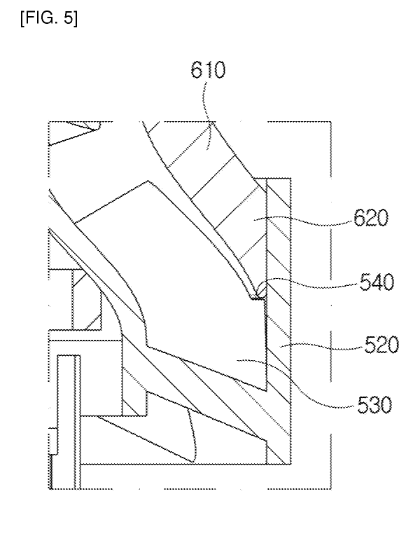

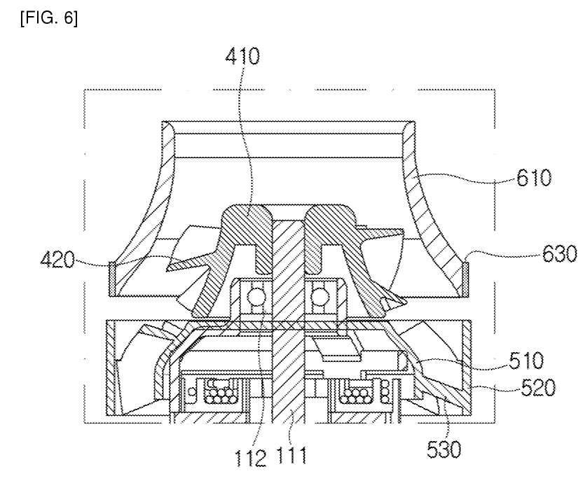

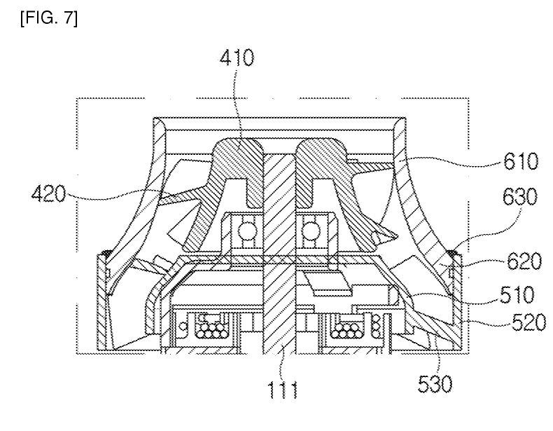

Meanwhile, FIG. 4 is a perspective view illustrating a guide vane in a fan motor according to an embodiment of the present disclosure, FIG. 5 is a cross-sectional view illustrating a cover coupling groove in a fan motor according to an embodiment of the present disclosure, FIG. 6 is a cross-sectional view illustrating an assembly process of a fan motor according to an embodiment of the present disclosure, and FIG. 7 is a cross-sectional view illustrating an assembled state of a fan motor according to an embodiment of the present disclosure.

Referring to FIGS. 1 to 7, the guide vane 500 and impeller cover 600 according to an embodiment of the present disclosure will be described as follows.

The guide vane 500 may be provided between the impeller 400 and the motor 100.

The guide vane 500 may guide the flow of air discharged from the impeller 400.

The guide vane 500 may include an inner wall 510, an outer wall 520, and vane blades 530. The plurality of vane blades 530 may be provided along the circumference between the inner wall 510 and the outer wall 520.

The inner wall 510 may be formed in a cylindrical shape with a partially closed upper portion. An opening may be formed in the inner wall 510 into which the upper bearing housing 210 of the motor bracket 200 is inserted. The shape of the opening of the inner wall 510 may correspond to the shape of the upper bearing housing 210. For example, the opening may be a circular hole.

At least a portion of the motor bracket 200 may be accommodated within the inner wall 510. Furthermore, the plurality of vane blades 530 may be formed along the circumferential direction on the outer surface of the inner wall 510.

The outer wall 520 may be formed in a cylindrical shape. The outer wall 520 may be positioned radially outside the inner wall 510. At this time, the inner diameter of the outer wall 520 may be greater than the outer diameter of the impeller cover 600. That is, the maximum diameter of the guide vane 500 may be greater than the maximum diameter of the impeller cover 600.

With this configuration, the outer surface of the impeller cover 60 may be inserted and joined to the inner surface of the outer wall 520.

At this time, the outer wall 520 may be formed to have a predetermined height along the axial direction. For example, the height of the outer wall 520 may be greater than or equal to the height of the inner wall 510. In another example, the height of the outer wall 520 may be greater than or equal to the maximum height of the vane blade 530.

With this configuration, the outer wall 520 has a portion extending upward from the portion connected to the vane blade 530. Accordingly, the impeller cover 600 may be coupled to the inner circumferential surface extending upward from the vane blade 530.

The vane blade 530 may connect the outer circumferential surface of the inner wall 510 and the inner circumferential surface of the outer wall 520. The vane blade 530 may guide the flow of air discharged from the impeller 400.

Meanwhile, in the present disclosure, the vane blade 530 includes all known shapes of various types.

Meanwhile, the radially outer end of the vane blade 530 may be formed to be recessed downward to form a cover coupling groove 540. At this time, since the vane blades 530 are arranged in a plurality along the circumferential direction, the cover coupling groove 540 may be arranged between the radially outer end of the vane blade 530 and the inner peripheral surface of the outer wall 520, and may be a groove formed in the circumferential direction.

At this time, the radial width of the cover coupling groove 540 may be greater than the radial width of one axial end of the impeller cover 600.

Therefore, when the impeller cover 600 is coupled to the guide vane 500, one axial end of the impeller cover 600 may be accommodated in the cover coupling groove 540. That is, the lower end of the insertion portion 620 of the impeller cover 60 may be accommodated in the cover coupling groove 540.

With this configuration, the gap between the radially outer end of the vane blade 530 and the impeller cover 600 may be minimized. Accordingly, there is an effect of preventing a decrease in flow efficiency.

The impeller cover 600 may accommodate the impeller 400 therein. The impeller cover 600 may be configured in a roughly hollow cylindrical shape. An opening at the top of the impeller cover 600 may serve as an air inlet 611 through which air is introduced.

The impeller cover 600 may have a diameter that increases from top to bottom. The diameter of the outer circumferential surface of the impeller cover 600 may be equal to or slightly smaller than the diameter of the inner circumferential surface of the outer wall 520 of the guide vane 500. Accordingly, at least a portion of the outer circumferential surface of the impeller cover 600 may be coupled to the inner circumferential surface of the outer wall 520 of the guide vane 500.

Specifically, the impeller cover 600 may include a cover body 610 whose outer diameter increases as it approaches the guide vane 500, and the insertion portion 620 that extends from the cover body 610 and is inserted into and coupled to the outer wall 520 of the guide vane 500.

Therefore, according to the present disclosure, since the impeller cover 600 is inserted into the inner circumferential surface of the outer wall of the guide vane 500, there is an effect of reducing the maximum outer diameter of the fan motor 1.

This is because only the outer diameter of the impeller cover 600 may be reduced, thereby reducing the overall outer diameter, without reducing the outer diameter of the guide vane 500, which affects the diameter of the vane blade 530 or the diameter of the impeller 400.

Therefore, there is an effect of reducing the maximum outer diameter of the fan motor 1, thereby enabling miniaturization and weight reduction. In addition, since the size of the impeller 400 or the vane blade 530 is not reduced, there is an advantage of not reducing the suction power of the fan motor 1 itself.

Meanwhile, the insertion portion 620 may have an adhesive 630 applied to the outer circumference thereof. At this time, when the insertion portion 620 is inserted into the outer wall 520 of the guide vane 500, the adhesive may be disposed between the outer circumference of the insertion portion 620 and the inner circumference of the outer wall 520, thereby bonding the outer circumference of the insertion portion 620 and the inner circumference of the outer wall 520. In addition, during the process of inserting the insertion portion 620 into the outer wall 520 of the guide vane 500, a portion of the adhesive may be compressed between the insertion portion 620 and the outer wall 520 and exposed to the upper side of the insertion portion 620.

Therefore, when the insertion portion 620 is inserted into the outer wall 520 of the guide vane 500, the adhesive may seal the space between at least a portion of the outer surface of the cover body 610 and the inner surface of the outer wall 520 of the guide vane 500.

In the case of conventional fan motors, since the guide vane is attached to the inner side of the impeller cover, the adhesive applied to the inner surface of the impeller cover is exposed to the inside of the flow path. Consequently, the adhesive leaked into the flow path and solidified, blocking a portion of the flow path, reducing flow path efficiency.

In contrast, according to the present disclosure, since the impeller cover 600 is structured to be inserted into the inside of the guide vane 500, the adhesive applied to the outer surface of the impeller cover 600 only leaks outward (upper) of the impeller cover 600 during the process of coupling the impeller cover 600 and the guide vane 500. Therefore, there is an effect of being able to prevent the internal flow path from being blocked by the adhesive, thereby reducing the flow path efficiency.

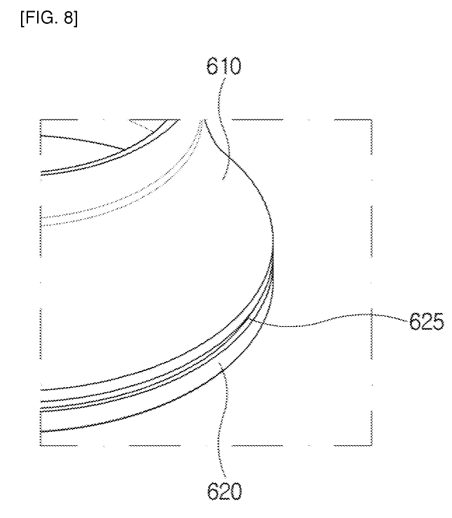

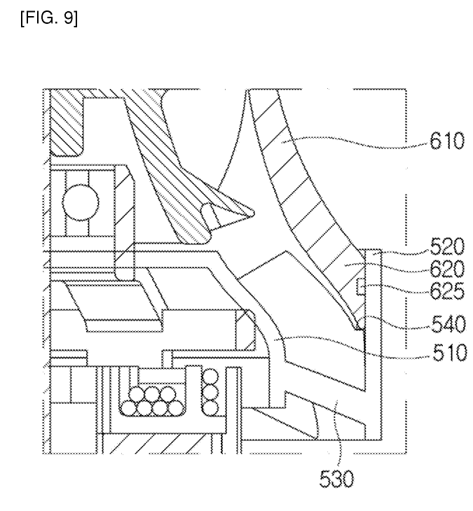

Meanwhile, FIG. 8 illustrates a drawing for explaining a bonding groove in a fan motor according to an embodiment of the present disclosure, and FIG. 9 illustrates a cross-sectional view for explaining a bonding groove in a fan motor according to an embodiment of the present disclosure.

Referring to FIGS. 8 and 9, an embodiment in which the bonding groove 625 is formed on the outer circumferential surface of the insertion portion 620 will be described as follows.

According to this embodiment, the bonding groove 625 may be further formed along the circumferential direction on the outer circumferential surface of the insertion portion 620. For example, the bonding groove 625 may be a linear groove formed along the outer circumferential surface of the insertion portion 620. Therefore, when the insertion portion 620 is inserted into the outer wall 520 of the guide vane 500, a space may be formed between the bonding groove 625 and the inner circumferential surface of the outer wall 520.

At this time, when adhesive 630 is applied to the outer surface of the insertion portion 620, some of the adhesive 630 may gather in the bonding groove 625. Therefore, when the insertion portion 620 is inserted into the outer wall 520 of the guide vane 500, a large amount of adhesive may gather in the space between the bonding groove 625 and the inner surface of the outer wall 520, and the adhesive may harden in this state.

Therefore, according to the present embodiment, a large amount of adhesive 630 may be present along the bonding groove 625, and when the insertion portion 620 is inserted into the guide vane 500, the bonding effect may be strengthened along the bonding groove 625.

Although the present disclosure has been described with reference to the exemplified drawings, it is to be understood that the present disclosure is not limited to the embodiments and drawings disclosed in this specification, and those skilled in the art will appreciate that various modifications are possible without departing from the scope and spirit of the present disclosure.

Further, although the operating effects according to the configuration of the present disclosure are not explicitly described while describing an embodiment of the present disclosure, it should be appreciated that predictable effects are also to be recognized by the configuration.

### Description of Numeral References

1: Fan motor

100: Motor

110: Rotor

111: Shaft

120: Stator

200: Motor bracket

210: Upper bearing housing

220: Support portion

230: Bridge

300: Motor housing

310: Moto housing body

320: Lower bearing housing

330: Connecting portion

400: Impeller

410: Hub

420: Blade

500: Guide vane

510: Inner wall

520: Outer wall

530: Vane

540: Cover coupling groove

600: Impeller cover

610: Cover body

620: Insertion portion

630: Adhesive

1. A fan motor comprising:
an impeller configured to suction air as it rotates about a shaft of a motor;
an impeller cover configured to accommodate the impeller therein; and
a guide vane configured to guide air discharged from the impeller,
wherein at least a portion of an outer peripheral surface of the impeller cover is coupled to an inner peripheral surface of an outer wall of the guide vane.

2. The fan motor of claim 1, wherein the guide vane further comprises an inner wall having a plurality of vane blades formed on an outer peripheral surface thereof, and
the plurality of vane blades are connected to an inner peripheral surface of the outer wall.

3. The fan motor of claim 2, wherein the guide vane has a cover coupling groove formed along a circumferential direction between a radially outer end of the vane blade and the inner peripheral surface of the outer wall.

4. The fan motor of claim 3, wherein an axially one end of the impeller cover is accommodated in the cover coupling groove.

5. The fan motor of claim 1, wherein a diameter of an outer peripheral surface of the impeller cover is equal to a diameter of an inner peripheral surface of the outer wall of the guide vane.

6. The fan motor of claim 1, wherein the impeller cover comprises:
a cover body having an outer diameter that increases toward the guide vane; and
an insertion portion inserted into and coupled to an outer wall of the guide vane.

7. The fan motor of claim 6, wherein an adhesive is applied to an outer peripheral surface of the insertion portion.

8. The fan motor of claim 7, wherein, in a state where the insertion portion is inserted into an outer wall of the guide vane, the adhesive seals between at least a portion of an outer peripheral surface of the cover body and an inner peripheral surface of an outer wall of the guide vane.

9. The fan motor of claim 6, wherein a bonding groove is formed along a circumferential direction on an outer peripheral surface of the insertion portion.

10. The fan motor of claim 1, wherein a maximum diameter of the guide vane is greater than a maximum diameter of the impeller cover.

11. A fan motor comprising:
an impeller arranged to suction air as it rotates about a shaft of a motor;
an impeller cover configured to accommodate the impeller therein; and
a guide vane arranged to guide air discharged from the impeller,
wherein the impeller cover comprises:
a cover body having an outer diameter that increases toward the guide vane; and
an insertion portion extending from an end of the cover body in a direction toward the guide vane along an axial direction, and inserted into and coupled to an inner peripheral surface of an outer wall of the guide vane.

12. The fan motor of claim 11, wherein the guide vane comprises:
an inner wall having a plurality of vane blades formed on an outer peripheral surface thereof;
an outer wall to which the vane blades are connected on an inner peripheral surface thereof; and
a plurality of cover coupling grooves formed at radially outer ends of the vane blades and arranged along a circumferential direction,
wherein a height from the cover coupling groove to an upper end of the outer wall is greater than a height of the insertion portion.

13. The fan motor of claim 12, wherein an adhesive is applied to an outer peripheral surface of the insertion portion, and when the insertion portion is inserted into an inner peripheral surface of the outer wall, a portion of the adhesive seals an upper side of the insertion portion and an inner peripheral surface of the outer wall.
